(19) United States
(12) Patent Application Publication
(10) Pub. No.: US 2021/0086436 A1
(43) Pub. Date: Mar. 25, 2021

(54) SYSTEM FOR ADDITIVELY MANUFACTURING COMPOSITE STRUCTURE

(71) Applicant: Continuous Composites Inc., Coeur d'Alene, ID (US)

(72) Inventors: Trevor David BUDGE, Coeur d'Alene, ID (US); Nathan Andrew Stranberg, Post Falls, ID (US)

(73) Assignee: Continuous Composites Inc., Coeur d'Alene, ID (US)

(21) Appl. No.: 16/947,164

(22) Filed: Jul. 21, 2020

Related U.S. Application Data
(60) Provisional application No. 62/904,999, filed on Sep. 24, 2019.

(51) Int. Cl. B29C 64/106; B29C 64/209; B29C 64/188; B29C 64/264; B29C 64/295; B29C 64/393; B29C 64/314; B29C 64/241; B29C 64/232

(52) U.S. Cl. CPC B29C 64/106; B29C 64/209; B29C 64/188; B29C 64/264; B33Y 10/00; B29C 64/393; B29C 64/314; B29C 64/241; B29C 64/232; B29C 64/295

(57) ABSTRACT

A system is disclosed for us in additively manufacturing a composite structure. The system may include a support, and a print head connected to and moveable by the support. The print head may include a wetting mechanism configured to at least partially wet a continuous reinforcement with a matrix at a location inside the print head, and an outlet configured to discharge the coated continuous reinforcement. The print head may also include a compactor located downstream of the outlet and configured to compact the coated continuous reinforcement, a cure enhancer configured to expose the matrix to a cure energy, and a temperature regulating element configured to regulate a temperature of the matrix at a location upstream of the cure enhancer.

### RELATED APPLICATION

This application is based on and claims the benefit of priority from U.S. Provisional Application No. 62/904,999 that was filed on Sep. 24, 2019, the contents of which are expressly incorporated herein by reference.

### TECHNICAL FIELD

The present disclosure relates generally to a manufacturing system and, more particularly, to a system for additively manufacturing composite structures.

### BACKGROUND

Continuous fiber 3D printing (a.k.a., CF3D®) involves the use of continuous fibers embedded within a matrix discharging from a moveable print head. The matrix can be a traditional thermoplastic, a powdered metal, a liquid resin (e.g., a UV curable and/or two-part resin), or a combination of any of these and other known matrixes. Upon exiting the print head, a head-mounted cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space. When fibers, particularly continuous fibers, are embedded within the structure, a strength of the structure may be multiplied beyond the matrix-dependent strength. An example of this technology is disclosed in U.S. Pat. No. 9,511,543 that issued to Tyler on Dec. 6, 2016 (“the '543 patent”).

Although CF3D® provides for increased strength, compared to manufacturing processes that do not utilize continuous fiber reinforcement, improvements can be made to the structure and/or operation of existing systems. For example, Applicant has found that greater control over compacting of the reinforcement can improve reinforcement placement, strength, and accuracy. The disclosed additive manufacturing system is uniquely configured to provide these improvements and/or to address other issues of the prior art.

### SUMMARY

In one aspect, the present disclosure is directed to an additive manufacturing system. The additive manufacturing system may include a support, and a print head connected to and moveable by the support. The print head may include a wetting mechanism configured to at least partially wet a continuous reinforcement with a matrix at a location inside the print head, and an outlet configured to discharge the coated continuous reinforcement. The print head may also include a compactor located downstream of the outlet and configured to compact the coated continuous reinforcement, a cure enhancer configured to expose the matrix to a cure energy, and a temperature regulating element configured to regulate a temperature of the matrix at a location upstream of the cure enhancer.

In another aspect, the present disclosure is directed to a method of additive manufacturing. The method may include at least partially wetting a continuous reinforcement with a matrix at a location inside a print head, discharging the coated continuous reinforcement through an outlet of the print head, and moving the print head during discharging. The method may also include compacting the coated continuous reinforcement discharging through the outlet of the print head, exposing the coated continuous reinforcement to a cure energy at a cure location, and regulating a temperature of the matrix at a location upstream of the cure location.

### BRIEF DESCRIPTION OF THE DRAWINGS

FIG. 1 is a diagrammatic illustration of an exemplary disclosed additive manufacturing system;

FIG. 2 is a diagrammatic illustration of an exemplary disclosed outlet that may form a portion of the system of FIG. 1;

FIGS. 3, 4, 5 and 6 are diagrammatic illustrations of an exemplary disclosed compactor that may form a portion of the outlet of FIG. 3; and

FIG. 7 is a flowchart depicting an exemplary operation of the system of FIG. 1.

### DETAILED DESCRIPTION

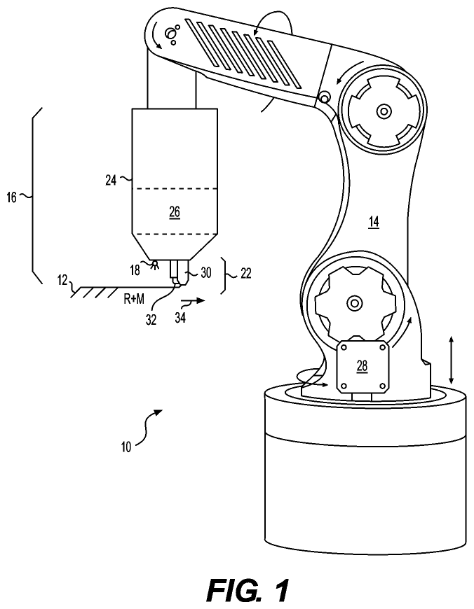

FIG. 1 illustrates an exemplary system 10, which may be used to manufacture a composite structure 12 having any desired shape. System 10 may include a support 14 and a deposition head (“head”) 16. Head 16 may be coupled to and moved by support 14. In the disclosed embodiment of FIG. 1, support 14 is a robotic arm capable of moving head 16 in multiple directions during fabrication of structure 12. Support 14 may alternatively embody a gantry (e.g., an overhead-bridge gantry or a single-post gantry) or a hybrid gantry/arm also capable of moving head 16 in multiple directions during fabrication of structure 12. Although support 14 is shown as being capable of 6-axis movements relative to structure 12, it is contemplated that support 14 may be capable of moving head 16 in a different manner (e.g., along and/or around a greater or lesser number of axes). It is also contemplated that structure 12 could be associated with one more movement axis and configured to move independent of and/or in coordination with support 14. In some embodiments, a drive may mechanically couple head 16 to support 14, and include components that cooperate to move portions of and/or supply power or materials to head 16.

Head 16 may be configured to receive or otherwise contain a matrix (shown as M). The matrix may include any type(s) or combination(s) of materials (e.g., a liquid resin, such as a zero-volatile organic compound resin, a powdered metal, etc.) that are curable. Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized (e.g., positively and/or negatively), for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16, and pushed or pulled out of head 16 along with one or more continuous reinforcements (shown as R). In some instances, the matrix inside head 16 may need to be kept cool and/or dark in order to inhibit premature curing or otherwise obtain a desired rate of curing after discharge. In other instances, the matrix may need to be kept warm and/or illuminated for similar reasons. In either situation, head 16 may be specially configured (e.g., insulated, temperature-controlled, shielded, etc.) to provide for these needs.

The matrix may be used to at least partially coat any number of continuous reinforcements (e.g., separate fibers, tows, rovings, socks, and/or sheets of continuous material) and, together with the reinforcements, make up a portion (e.g., a wall) of composite structure 12. The reinforcements may be stored within or otherwise passed through head 16. When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, plastic fibers, metallic fibers, optical fibers (e.g., tubes), etc. It should be noted that the term “reinforcement” is meant to encompass both structural and non-structural (e.g., functional) types of continuous materials that are at least partially encased in the matrix discharging from head 16.

The reinforcements may be at least partially coated with the matrix while the reinforcements are inside head 16, while the reinforcements are being passed to head 16, and/or while the reinforcements are discharging from head 16. The matrix, dry (e.g., unimpregnated) reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, nano particles or tubes, etc.) and/or additives (e.g., thermal initiators, UV initiators, etc.) may be mixed with the matrix before and/or after the matrix coats the continuous reinforcements.

One or more cure enhancers (e.g., a UV light, an ultrasonic emitter, a laser, a heater, a catalyst dispenser, etc.) 18 may be mounted proximate (e.g., within, on, and/or adjacent) head 16 and configured to enhance a cure rate and/or quality of the matrix as it is discharged from head 16. Cure enhancer 18 may be controlled to selectively expose portions of structure 12 to energy (e.g., UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, solidify the matrix, polymerize the matrix, or otherwise cause the matrix to cure as it discharges from head 16. The amount of energy produced by cure enhancer 18 may be sufficient to cure the matrix before structure 12 axially grows more than a predetermined length away from head 16. In one embodiment, structure 12 is at least partially (e.g., completely) cured before the axial growth length becomes equal to an external diameter of the matrix-coated reinforcement.

The matrix and/or reinforcement may be discharged together from head 16 via any number of different modes of operation. In a first example mode of operation, the matrix and/or reinforcement are extruded (e.g., pushed under pressure and/or mechanical force) from head 16 as head 16 is moved by support 14 to create features of structure 12. In a second example mode of operation, at least the reinforcement is pulled from head 16, such that a tensile stress is created in the reinforcement during discharge. In this second mode of operation, the matrix may cling to the reinforcement and thereby also be pulled from head 16 along with the reinforcement, and/or the matrix may be discharged from head 16 under pressure along with the pulled reinforcement. In the second mode of operation, where the reinforcement is being pulled from head 16, the resulting tension in the reinforcement may increase a strength of structure 12 (e.g., by aligning the reinforcements, inhibiting buckling, equally loading the reinforcements, etc.) after curing of the matrix, while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor point (e.g., a print bed, a previously fabricated surface of structure 12, a fixture, etc.). For example, at the start of structure formation, a length of matrix-impregnated reinforcement may be pulled and/or pushed from head 16, deposited against the anchor point, and at least partially cured, such that the discharged material adheres (or is otherwise coupled) to the anchor point. Thereafter, head 16 may be moved away from the anchor point, and the relative movement may cause the reinforcement to be pulled from head 16. In some embodiments, the movement of reinforcement through head 16 may be selectively assisted via one or more internal feed mechanisms, if desired. However, the discharge rate of reinforcement from head 16 may primarily be the result of relative movement between head 16 and the anchor point, such that tension is created within the reinforcement. As discussed above, the anchor point could be moved away from head 16 instead of or in addition to head 16 being moved away from the anchor point.

Head 16 may include, among other things, an outlet 22 and a matrix reservoir 24 located upstream of outlet 22. In one example, outlet 22 is a single-channel outlet configured to discharge composite material having a generally circular, tubular, or rectangular cross-section. The configuration of head 16, however, may allow outlet 22 to be swapped out for another outlet that simultaneously discharges multiple channels of composite material having the same or different shapes (e.g., a flat or sheet-like cross-section, a multi-track cross-section, etc.). Fibers, tubes, and/or other reinforcements may pass through matrix reservoir 24 (e.g., through one or more internal wetting mechanisms 26 located inside of reservoir 24) and be wetted (e.g., at least partially coated, encased, and/or fully saturated) with matrix prior to discharge.

Outlet 22 may take different forms. In one example, a guide or nozzle 30 is located downstream of wetting mechanism 26, and a compactor 32 trails nozzle 30 (e.g., relative to a normal travel direction of head 16 during material discharge, as represented by an arrow 34). It is contemplated that either of nozzle 30 or compactor 32 may function as a tool center point (TCP) of head 16, to affix the matrix-wetted reinforcement(s) at a desired location prior to and/or during curing when exposed to energy by cure enhancer(s) 18. It is also contemplated that nozzle 30 and/or compactor 32 may be omitted, in some embodiments. Finally, it is contemplated that the TCP of head 16 may not necessarily be associated with nozzle 30 or compactor 32 and instead be a location of cure energy exposure that is separate from these locations. The TCP may also switch locations in some applications.

One or more controllers 28 may be provided and communicatively coupled with support 14 and head 16. Each controller 28 may embody a single processor or multiple processors that are programmed and/or otherwise configured to control an operation of system 10. Controller 28 may include one or more general or special purpose processors or microprocessors. Controller 28 may further include or be associated with a memory for storing data such as, for example, design limits, performance characteristics, operational instructions, tool paths, and corresponding parameters of each component of system 10. Various other known circuits may be associated with controller 28, including power supply circuitry, signal-conditioning circuitry, solenoid driver circuitry, communication circuitry, and other appropriate circuitry. Moreover, controller 28 may be capable of communicating with other components of system 10 via wired and/or wireless transmission.

One or more maps may be stored within the memory of controller 28 and used during fabrication of structure 12. Each of these maps may include a collection of data in the form of lookup tables, graphs, and/or equations. In the disclosed embodiment, the maps may be used by controller 28 to determine movements of head 16 required to produce desired geometry (e.g., size, shape, material composition, performance parameters, and/or contour) of structure 12, to regulate operation of one or more temperature controlling peripherals associated with the matrix, and/or to regulate operation of cure enhancer(s) 18 and/or other related components in coordination with the movements.

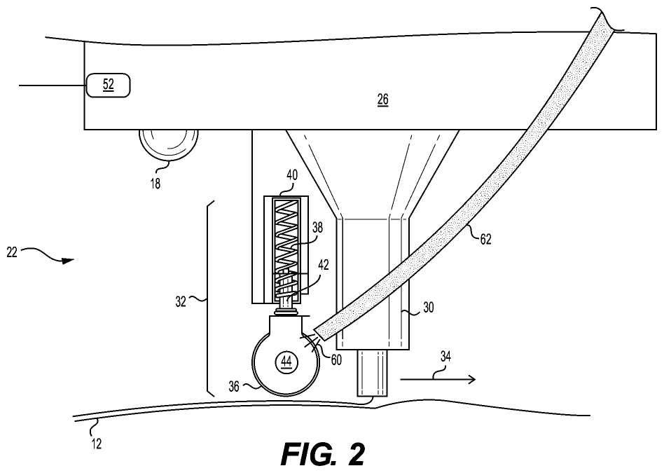

An exemplary outlet 22 is illustrated in FIG. 2. As shown in this figure, compactor 32 may include a compacting device (e.g., a wheel) 36 that is biased against the matrix-coated reinforcement (R+M) via a spring 38. Spring 38 may be disposed within a housing 40 and configured to exert an axially extending force on compacting device 36 via one or more pistons 42 that protrude at least partially in housing 40. In the disclosed embodiment, compacting device 36 is generally cylindrical and oriented orthogonally relative to a central axis of nozzle 30, with one piston 42 located at each opposing end and extending parallel with the central axis. Each piston 42 may be connected to compacting device 36 via a corresponding bearing 44.

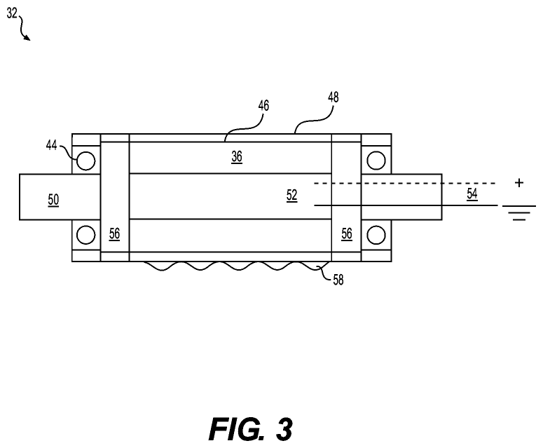

As shown in FIGS. 3-6, compacting device 36 may be provided with one or more outer covers. The covers may include, for example, a compliant inner cover 46 and a harder or more rigid outer cover 48. The compliance of inner cover 46 may allow for adequate engagement and compression forces on the reinforcement and/or result in a flat spot at an area of engagement with structure 12 (referring to FIG. 1). This flat spot may help the matrix-wetted reinforcement disengage from compactor 32 and adhere to only structure 12, and also help the reinforcement to lay flat against an underlying layer of structure 12. Outer cover 48 may be fabricated from a low-friction material (e.g., Polytetrafluoroethylene—PTFE, Fluorinated ethylene propylene—FEP, etc.) that further facilitates disengagement of the reinforcement from compactor 32.

In some embodiments, outer cover 48 of compacting device 36 may have a finish designed to provide a desired effect on the composite material being compacted. For example, compacting device 36 may have a textured surface (e.g., with raised or recessed dimples 58) that increase an exposed surface area of the composite material during compaction. This increased surface area may improve layer-to-layer adhesion when an overlapping layer is subsequently compacted onto an underlying layer (e.g., when material from the overlapping layer is pressed into or around dimples 58). Alternatively, compacting device 36 may have a smoother surface (e.g., free of dimples 58) for use when compacting a final or outer layer of structure 12. It is contemplated that system 10 may be capable of swapping out heads 16 (or just outlets 22) having different compactors 32 to adjust the surface texture of structure 12 during compacting. It is also contemplated that only compactors 32, only compacting devices 36, and/or only outer covers 48 may be selectively swapped out, as desired.

In some applications, energy (e.g., heat) in addition to or as an alternative to the energy provided by cure enhancer(s) 18 may be beneficial in curing the matrix of the composite material discharging from head 16. This heat imparted to the matrix prior to exposure by energy from cure enhancer(s) 18 may reduce an amount of energy required from cure enhancer(s) 18 to initiate a desired rate of curing, reduce an amount of time required for curing to complete, and/or affect (e.g., increase) a resulting glass transition temperature Tg of the cured matrix.

As shown in FIG. 3, the heat may be applied to the matrix via compactor 32. For example, compacting device 36 may be fabricated from a material that conducts heat, and compactor 32 may include a temperature regulating element (e.g., a source of heat) mounted inside of compacting device 36 (e.g., inside of axle 50 at a location inside of compacting device 36 or only inside of compacting device 36 at a distance radially offset from axle 50). In one instance, the temperature regulating element includes one or more resistive electrodes or cartridges 52, and leads 54 that provide power to cartridges 52. Leads 54 may extend axially out of compactor 32 and/or terminate at a slipring (not shown), as desired. Alternatively, leads 54 and/or cartridges 52 may be embedded within a stationary component around which compacting device 36 rotates. It is contemplated that some or all of compactor 32 (e.g., compacting device 36) may be thermally isolated from other components of head 16, for example via a mounting plate 56 located at each axial end.

It should be noted that, in addition to or instead of the external heat provided by the temperature regulating element of compactor 32, the matrix may be heated at one or more locations inside of head 16. For example, a heating cartridge 52 may be embedded within a wall of reservoir 24, in direct contact with the matrix inside or reservoir 24, within a wall of nozzle 30, in direct contact with the matrix inside of nozzle 30, etc. In some applications, dual stages of heating may be implemented at locations inside of head 16 (e.g., a first lower stage in association with reservoir 24 and a second higher stage in association with nozzle 30. As will be explained in more detail in the following section, a temperature of the matrix induced by the heating cartridge 52 inside of head 16 may be coordinated with a temperature of compactor 32 induced by the heating cartridge 52 associated with compactor 32.

Although exemplary heating of compactor 32 has been described above and illustrated in FIG. 3, cooling of compactor 32 may also be selectively implemented. For example, one or both of inner and outer covers 46, 48 may have a maximum allowable operating temperature, above which integrity of the cover(s) may degrade. In this example, not only would heating of compactor 32 be limited to the maximum allowable operating temperature, but the temperature may be actively reduced in some situations. For example, cooling of compactor 32 may allow for greater heating of the matrix inside of head 16, without the temperature of compactor 32 exceeding the maximum allowable operating temperature.

Compactor 32 may be cooled in multiple ways. In one embodiment, a lower temperature medium (air, another inert gas, liquid coolant, etc.) 60 may be passed from a source 62 near, through, and/or against compacting device 36 to absorb and dissipate heat therefrom. The medium may be at room temperature or chilled to be cooler than room temperature, as desired. Alternatively, thermoelectric cooling or another type of temperature regulating element may be implemented.

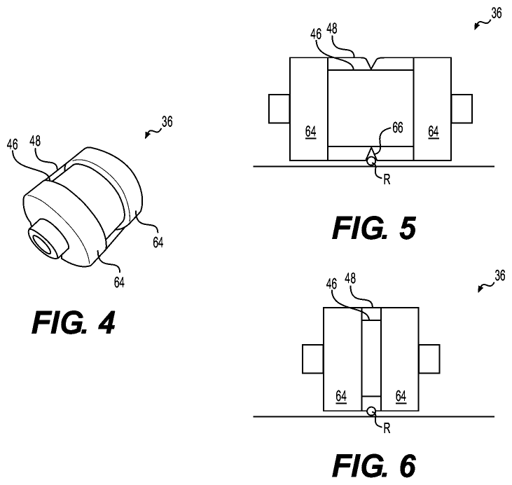

FIGS. 4, 5, and 6 illustrate different exemplary embodiments of compacting device 36. As shown in FIG. 4, one or more retaining rings 64 may be located at opposing axial ends of outer cover 48. Rings 64 may help to axially retain outer cover 48 at a desired location over a discharge and placement location of the reinforcement. It should be noted that rings 64 may or may not function as the thermally isolating mounting plates 56 described above. In one embodiment, rings 64 may have a surface characteristic (e.g., a smoothness, chemical composition, hardness, etc.) that inhibits sticking more so than outer cover 48. In addition, in some embodiments, a compliance of rings 64 may be greater than the compliance of inner cover 46, such that inner and outer covers 46, 48 are able to provide some compaction to the reinforcement (i.e., so that rings 64 compress enough to allow covers 46, 48 to press against the reinforcement).

As shown in FIG. 5, at least outer cover 48 may include one or more guides (e.g., annular grooves) 66 that function to generally retain the continuous reinforcement at an axial center of compacting device 36. In the embodiment of FIG. 6, guide(s) 66 may be omitted and, instead, rings 64 may be spaced an axial distance away from each other. The axial distance may be selected to inhibit substantial axial movement of the reinforcement away from the axial center plane of compacting device 36. In one embodiment, the axial distance may be about equal to or less than two times a diameter of the continuous reinforcement. It should be noted that, while the continuous reinforcement has been described as being guided at the axial center compacting device 36, the continuous reinforcement could alternatively be guided to a different axial position of compacting device 36, if desired.

It is also contemplated that, in the embodiment of FIG. 6, a compliance of inner and/or outer covers 46, 48, themselves (i.e., without the need for guiding by rings 64) may function to retain the continuous reinforcement at a desired axial location. For example, inner and/or outer covers 46, 48 may have a durometer value of about 10-30 A-shore, which allows the continuous reinforcement to be indented into the cover(s) during engagement of compaction device 36. During this pushing, a trough may be formed within inner and/or outer covers 46, 48 that inhibits transverse movements of the continuous reinforcement. It should be noted that, in some embodiments, the indentation should be less than one diameter of the continuous reinforcement, such that the continuous reinforcement can compress against an underlying surface.

In yet another embodiment similar to that of FIG. 6, instead of or in addition to inner and/or outer covers 46, 48 being compliant to form a trough that guides the continuous reinforcement, a center portion of compacting device 36 could be moveable in a radial direction without requiring the compliance of inner and/or outer covers 46, 48. For example, the center portion could be biased (e.g., via a spring) radially away from axle 50 and towards the continuous reinforcement.

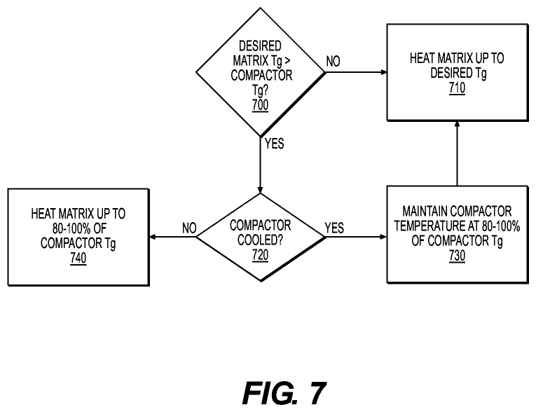

FIG. 7 illustrates an exemplary control process for regulating matrix temperatures during material discharge from head 16. FIG. 7 will be discussed in more detail below to further illustrate the disclosed concepts.

### INDUSTRIAL APPLICABILITY

The disclosed system may be used to manufacture composite structures having any desired shape and size. The composite structures may include any number of different fibers of the same or different types and of the same or different diameters, and any number of different matrixes of the same or different makeup. Operation of system 10 will now be described in detail.

At a start of a manufacturing event, information regarding a desired structure 12 may be loaded into system 10 (e.g., into controller 28 that is responsible for regulating operations of support 14 and/or head 16). This information may include, among other things, a size (e.g., diameter, wall thickness, length, etc.), a contour (e.g., a trajectories, surface normal, etc.), surface features (e.g., ridge size, location, thickness, length; flange size, location, thickness, length; etc.), connection geometry (e.g., locations and sizes of couplings, tees, splices, etc.), reinforcement selection and specification, matrix selection and specifications, discharge locations, curing specifications, compaction specifications, etc. It should be noted that this information may alternatively or additionally be loaded into system 10 at different times and/or continuously during the manufacturing event, if desired. Based on the component information, one or more different reinforcements and/or matrix materials may be installed and/or continuously supplied into system 10.

To install the reinforcements, individual fibers, tows, and/or ribbons may be passed through matrix reservoir 24 and outlet 22 (e.g., through nozzle 30 and under compactor 32). Installation of the matrix material may include filling head 16 (e.g., wetting mechanism 26 of reservoir 24) and/or coupling of an extruder (not shown) to head 16.

The component information may then be used to control operation of system 10. For example, the in-situ wetted reinforcements may be pulled and/or pushed from outlet 22 of head 16 as support 14 selectively moves (e.g., based on known kinematics of support 14 and/or known geometry of structure 12), such that the resulting structure 12 is fabricated as desired.

Operating parameters of support 14, cure enhancer(s) 18, reservoir 24, compactor 32, and/or other components of system 10 may be adjusted in real time during material discharge to provide for desired bonding, strength, tension, geometry, material properties, and other characteristics of structure 12.

As shown in FIG. 7, temperature of the matrix may be one of the operational parameters that are adjusted in real time during material discharge. Specifically, a temperature of the matrix within head 16 may be coordinated with a temperature of compacting device 36 to achieve a desired cure parameter and/or resulting material property, while ensuring longevity of compactor 32 (e.g., of outer cover 48).

For example, during operation of system 10, controller 28 may be programmed to determine if a resulting Tg of the matrix (i.e., after curing of the matrix within structure 12) is desired to be greater than an actual Tg of compactor 32 (i.e., of outer cover 47) (Step 700). This may be dependent on the particular matrix selected for use with head 16 and/or operator input regarding the desired matrix Tg. When the desired matrix Tg is not greater than the actual Tg of compactor 32 (Step 700:N), controller 28 may be programmed to selectively increase the temperature of the matrix up to the desired temperature at the location inside of head 16 and/or at compactor 32 (Step 710). This heating may be accomplished, for example, via selective activation of the heater cartridge(s) within head 16 and/or associated with compactor 32.

However, when controller 28 determines at Step 700 that the desired matrix Tg is greater than the compactor Tg (Step 700:Y), controller 28 may instead be programmed to determine if compactor 32 is capable of being actively cooled (Step 720). This may be dependent on the configuration of the particular outlet 22 connected to head 16 at the time of material discharge and detected automatically (e.g., via recognition of electronic indicia) or determined based on operator input (e.g., input received at startup of system 10).

When compactor 32 is capable of being actively cooled (e.g., via flow regulation of the directed cool medium, activation of the thermoelectronics, etc.) (Step 720:Y), controller 28 may be programmed to maintain a temperature of compactor 32 at or below the Tg of compactor 32 (e.g., at about 80-100% of the Tg, within engineering tolerances) (Step 730). This may help prolong the longevity of compactor 32 (e.g., outer cover 48). At the same time that controller 28 maintains the temperature of compactor 32 at or below the Tg of compactor 32, controller 28 may be programmed to heat the matrix up to the desired Tg (Step 710), even if when the desired Tg is greater than the Tg of compactor 32.

In some applications, the temperature of the matrix may increase as a result of the chemical reaction occurring during curing. In these applications, controller may be programmed at Step 710 to heat the matrix to a temperature below the desired Tg but that results in the matrix reaching the desired Tg during the chemical reaction. In this way, the temperature of the matrix does not significantly exceed the desired Tg during the chemical reaction.

However, when controller 28 determines that compactor 32 is not capable of being actively cooled (Step 720:N), controller 28 may be programmed to limit matrix heating of the matrix to a temperature at or below the Tg of compactor 32 (Step 740). For example, controller 28 may activate heating cartridges 52 to heat the matrix only to about 80-100% of the Tg of compactor 32.

As discussed above, multiple benefits may be associated with the disclosed system. For example, curing of the matrix may be completed quickly, thoroughly, and/or with less energy through the use of matrix heating prior to cure initiation by cure enhancer(s) 18. In addition, specific glass transition temperatures may be achieved via preheating of the matrix to desired temperatures. Further, a life of compactor 32 may be prolonged via active temperature control. Finally, placement control over the reinforcement may be enhanced through use of the disclosed compactor designs.

It will be apparent to those skilled in the art that various modifications and variations can be made to the disclosed system. Other embodiments will be apparent to those skilled in the art from consideration of the specification and practice of the disclosed system. For example, although compactor 32 is disclosed in one embodiment as having a lower temperature medium (air, another inert gas, liquid coolant, etc.) 60 passing through, near, and/or against a component of compactor 32 to absorb and dissipate heat therefrom, the medium could alternatively be a high-temperature medium that increases a temperature of compactor 32, if desired. It is intended that the specification and examples be considered as exemplary only, with a true scope being indicated by the following claims and their equivalents.

What is claimed is:

1. An additive manufacturing system, comprising:
a support; and
a print head connected to and moveable by the support, the print head including:
a wetting mechanism configured to at least partially wet a continuous reinforcement with a matrix at a location inside the print head;
an outlet configured to discharge the coated continuous reinforcement;
a compactor located downstream of the outlet and configured to compact the coated continuous reinforcement;
a cure enhancer configured to expose the matrix to a cure energy; and
a temperature regulating element configured to regulate a temperature of the matrix at a location upstream of the cure enhancer.

2. The additive manufacturing system of claim 1, wherein the cure enhancer is located to expose the matrix to a cure energy at a location that is at least one of downstream of the compactor and at a nip point of the compactor.

3. The additive manufacturing system of claim 1, wherein the cure energy is UV light.

4. The additive manufacturing system of claim 1, wherein the temperature regulating element is a heater.

5. The additive manufacturing system of claim 4, wherein the heater is located at least one of associated with the compactor and within the print head at a position upstream of the compactor.

6. The additive manufacturing system of claim 5, wherein:
the heater is a first heater associated with the compactor; and
the additive manufacturing system further includes a second heater located at the position upstream of the compactor.

7. The additive manufacturing system of claim 5, further including a controller programmed to selectively activate the heater to heat the matrix up to a desired glass transition temperature of the matrix when the desired glass transition temperature of the matrix is less than a glass transition temperature of the compactor.

8. The additive manufacturing system of claim 5, further including a controller programmed to limit a temperature reached within the matrix to a glass transition temperature of the compactor.

9. The additive manufacturing system of claim 5, wherein:
the heater is located at the position upstream of the compactor; and
the additive manufacturing system includes a second temperature regulating element configured to cool the compactor.

10. The additive manufacturing system of claim 9, wherein the second temperature regulating element includes a source of cool medium.

11. The additive manufacturing system of claim 9, further including a controller programmed to coordinate operation of the heater and the second temperature regulating element based on a glass transition temperature.

12. The additive manufacturing system of claim 11, wherein the controller is programmed to selectively activate the heater to heat the matrix up to a desired glass transition temperature of the matrix and to activate the second temperature regulating element to cool the compactor when the desired glass transition temperature of the matrix is greater than a glass transition temperature of the compactor.

13. A method of additive manufacturing, comprising:
at least partially wetting a continuous reinforcement with a matrix at a location inside a print head;
discharging the coated continuous reinforcement through an outlet of the print head;
moving the print head during discharging;
compacting the coated continuous reinforcement discharging through the outlet of the print head;
exposing the coated continuous reinforcement to a cure energy at a cure location; and
regulating a temperature of the matrix at a location upstream of the cure location.

14. The method of claim 13, wherein regulating the temperature of the matrix includes heating the matrix.

15. The method of claim 14, wherein heating the matrix includes at least one of heating the matrix at a location of the compacting or heating the matrix at a location upstream of the location of the compacting.

16. The method of claim 15, wherein:
compacting the coated continuous reinforcement includes compacting the coated continuous reinforcement with a compactor; and
heating the matrix includes selectively heating the matrix at the location upstream of the location of the compacting up to a desired glass transition temperature of the matrix when the desired glass transition temperature of the matrix is less than a glass transition temperature of the compactor.

17. The method of claim 15, wherein:
compacting the coated continuous reinforcement includes compacting the coated continuous reinforcement with a compactor; and
the method further includes limiting heating of the matrix to a glass transition temperature of the compactor.

18. The method of claim 15, wherein:
compacting the coated continuous reinforcement includes compacting the coated continuous reinforcement with a compactor;
heating the matrix includes selectively heating the matrix at the location upstream of the location of the compacting; and
the method further includes cooling the compactor.

19. The method of claim 18, further including coordinating the selectively heating and the cooling based on a glass transition temperature.

20. The method of claim 18, further including selectively heating the matrix up to a desired glass transition temperature of the matrix and selectively cooling the compactor when the desired glass transition temperature of the matrix is greater than a glass transition temperature of the compactor.
